(19) United States
(12) Patent Application Publication
(10) Pub. No.: US 2025/0126659 A1
(43) Pub. Date: Apr. 17, 2025

(54) WIRELESS COMMUNICATION SYSTEM AND WIRELESS COMMUNICATION METHOD

(71) Applicant: NTT DOCOMO, INC., Tokyo (JP)

(72) Inventors: Yuki Hokazono, Chiyoda-ku, Tokyo (JP); Yoshihisa Kishiyama, Chiyoda-ku, Tokyo (JP); Hinata Kohara, Chiyoda-ku, Tokyo (JP)

(73) Assignee: NTT DOCOMO, INC., Tokyo (JP)

(21) Appl. No.: 18/834,138

(22) PCT Filed: Dec. 28, 2022
(86) PCT No.: PCT/JP2022/048443

§ 371 Date: Jul. 29, 2024

(30) Foreign Application Priority Data
Feb. 9, 2022 (JP) 2022-018544

(51) Int. Cl. H04W 76/10

(52) U.S. Cl. CPC H04W 76/10

(57) ABSTRACT

A wireless communication system includes: a non-terrestrial device and a terrestrial device. The non-terrestrial device includes: a first control unit configured to establish a service link with a terminal and establish a feeder link with the terrestrial device; and a first communication unit configured to provide a relay between the service link and the feeder link, and the terrestrial device includes: a second control unit configured to establish the feeder link with the non-terrestrial device and establish a fronthaul with a base station; and a second communication unit configured to provide conversion between a signal of the fronthaul and a signal of the feeder link.

### FIELD OF THE INVENTION

The present invention relates to a wireless communication system and a wireless communication method.

### BACKGROUND OF THE INVENTION

Regarding NR (New Radio) (also referred to as “5G”), or a successor system to LTE (Long Term Evolution), technologies have been discussed which satisfy the following requirements: a high capacity system, high data transmission rate, low delay, simultaneous connection of multiple terminals, low cost, power saving, etc. (for example, Non-Patent Document 1).

Currently, NTN (Non-Terrestrial Network) is also discussed. The NTN provides services to an area that cannot be covered by a terrestrial 5G network mainly due to the cost aspect, by using a non-terrestrial network such as a satellite (Non-Patent Document 2 and Non-Patent Document 3).

### CITATION LIST

### Non-Patent Document

Non-Patent Document 1: 3GPP TS 38.300 V16.8.0 (2021-12)

Non-Patent Document 2: 3GPP TR 38.821 V16.0.0 (2019-12)

Non-Patent Document 3: Konishi, et al., “A Study of Downlink Spectrum Sharing in HAPS Mobile Communication System”, the Institute of Electronics, Information and Communication Engineers (IEICE) General Conference, B-17-1, 2020

### SUMMARY OF THE INVENTION

### Technical Problem

Enhancement of the broadband area using NTN is being discussed. For example, in order to improve the area coverage of millimeter waves in particular, a method of implementing the coverage by a combination of a HAPS (High Altitude Platform Station) system and a terrestrial network may be more economical than a method of implementing the coverage by only a terrestrial network. However, the said method has not been established.

The present invention has been made in view of the above points, and it is an object of the present invention to enhance service areas by causing the NTN (Non-Terrestrial Network) and the terrestrial network to cooperate with each other.

### Solution to Problem

According to the disclosed technology, a wireless communication system including: a non-terrestrial device; and a terrestrial device is provided. The non-terrestrial device includes: a first control unit configured to establish a service link with a terminal and establish a feeder link with the terrestrial device; and a first communication unit configured to provide a relay between the service link and the feeder link, and the terrestrial device includes: a second control unit configured to establish the feeder link with the non-terrestrial device and establish a fronthaul with a base station; and a second communication unit configured to provide conversion between a signal of the fronthaul and a signal of the feeder link.

### Advantageous Effects of Invention

According to the disclosed technique, it is possible to enhance the service areas by causing the NTN (Non-Terrestrial Network) and the terrestrial network to cooperate with each other.

### BRIEF DESCRIPTION OF THE DRAWINGS

FIG. 1 is a drawing illustrating an example of an NTN.

FIG. 2 is a drawing illustrating an example of a terrestrial network.

FIG. 3 is a drawing illustrating an example (1) of an NTN system in an embodiment of the present invention.

FIG. 4 is a drawing illustrating an example (1) of a beam operation in an embodiment of the present invention.

FIG. 5 is a drawing illustrating an example (2) of a beam operation in an embodiment of the present invention.

FIG. 6 is a drawing illustrating an example (1) of a frequency operation in an embodiment of the present invention.

FIG. 7 is a drawing illustrating an example (2) of a frequency operation in an embodiment of the present invention.

FIG. 8 is a drawing illustrating an example (3) of a frequency operation in an embodiment of the present invention.

FIG. 9 is a drawing illustrating an example (2) of an NTN system in an embodiment of the present invention.

FIG. 10 is a drawing illustrating an example (3) of an NTN system in an embodiment of the present invention.

FIG. 11 is a drawing illustrating an example (4) of an NTN system in an embodiment of the present invention.

FIG. 12 is a drawing illustrating an example (5) of an NTN system in an embodiment of the present invention.

FIG. 13 is a drawing illustrating an example of a functional configuration of a base station 10 in an embodiment of the present invention.

FIG. 14 is a drawing illustrating an example of a functional configuration of a terminal 20 in an embodiment of the present invention.

FIG. 15 is a drawing illustrating an example of a hardware structure of the base station 10 or the terminal 20 in an embodiment of the present invention.

FIG. 16 is a drawing illustrating an example of a structure of a vehicle 2001 in an embodiment of the present invention.

### DETAILED DESCRIPTION OF THE PREFERRED EMBODIMENTS

In the following, referring to the drawings, one or more embodiments of the present invention will be described. It should be noted that the embodiments described below are examples. Embodiments of the present invention are not limited to the following embodiments.

In operations of a wireless communication system according to an embodiment of the present invention, a conventional technique will be used when it is appropriate. With respect to the above, for example, the conventional techniques are related to, but not limited to, the existing LTE. Further, it is assumed that the term “LTE” used in the present specification has, unless otherwise specifically mentioned, a broad meaning including a scheme of LTE-Advanced and a scheme after LTE-Advanced (e.g., NR).

Furthermore, in one or more embodiments described below, terms that are used in the existing LTE are used, such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), etc. The above-described terms are used for the sake of description convenience. Signals, functions, etc., which are similar to the above-described terms, may be referred to as different names. Further, the above terms in NR correspond to NR-SS, NR-PSS, NR-SSS, NR-PBCH, NR-PRACH, NR-PDCCH, NR-PDSCH, NR-PUCCH, NR-PUSCH, and the like. However, even when a signal is used for NR, there may be a case in which the signal is not referred to as “NR-”.

In addition, in an embodiment of the present invention, the duplex method may be a TDD (Time Division Duplex) method, an FDD (Frequency Division Duplex) method, or any other method (e.g., Flexible Duplex, or the like).

Further, in an embodiment of the present invention, the expression, radio (wireless) parameters are “configured (set)” may mean that a predetermined value is pre-configured, or may mean that a radio parameter indicated by a base station 10 or a terminal 20 is configured.

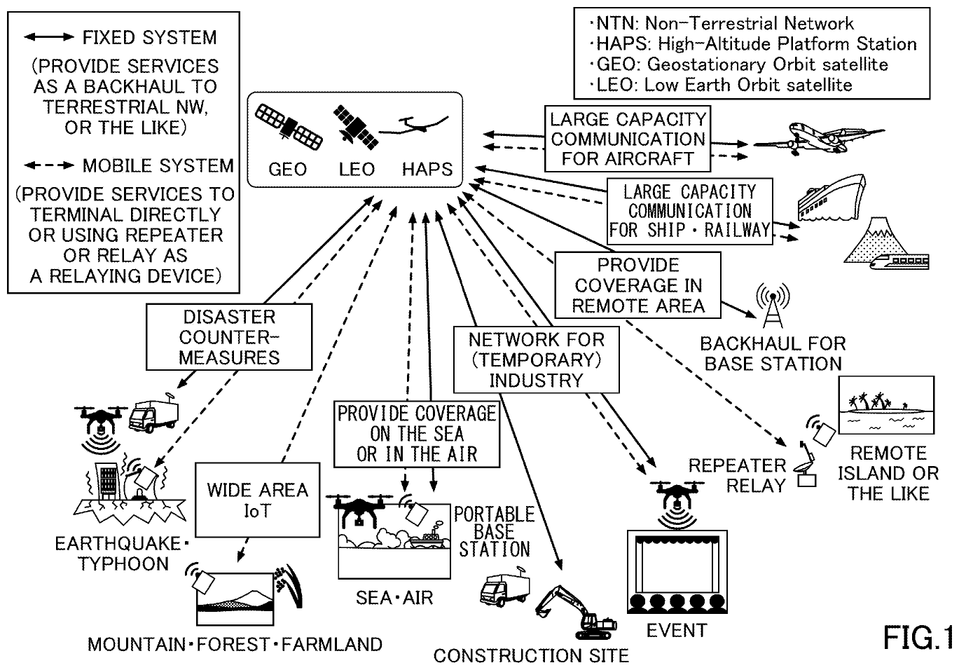

FIG. 1 is a drawing illustrating an example (1) of NTN. The NTN is a network that provides services to an area that cannot be covered by the terrestrial network mainly due to the cost aspect by using non-terrestrial devices such as a satellite or a high altitude platform station (HAPS). Further, services with higher reliability may be provided by NTN. For example, NTN may be assumed to be applied to IoT (Inter of things), ships, buses, trains, and critical communications. Further, NTN has scalability according to efficient multi-cast or broadcast.

As illustrated in FIG. 1, NTN is implemented by a satellite in space or a flying object in the air. For example, a satellite of GEO (Geostationary Orbit satellite) is located at an altitude of 35,786 km, and may be a satellite having a geostationary orbit. For example, a satellite of LEO (Low Earth Orbit satellite) may be a satellite located at altitude 500 to 2000 km, and may be a satellite with a turning flight of a period of 88 to 127 minutes. For example, a HAPS may be a flying object located at an altitude of 8 to 50 km and performing a turning flight.

As illustrated in FIG. 1, the GEO satellite, the LEO satellite, and the HAPS flying object may provide services of a fixed system and a mobile system. For example, the services of a fixed system may be a backhaul to the terrestrial network, or the like. For example, the services of a mobile system may be directly provided to the terminal 20, or may be provided to the terminal 20 by using relaying by a repeater or a relay. In addition, the service area increases in the order of HAPS, LEO, and GEO.

By using the NTN, as illustrated in FIG. 1, the network coverage can be enhanced with respect to an area to which services are not provided and to an area to which services are provided. In order to particularly achieve an enhancement of the area of millimeter waves, for example, 100% area coverage, it may be more economical to achieve it by a combination of the NTN and the terrestrial network than to achieve it by only the terrestrial network.

For example, as shown in FIG. 1, the NTN is assumed to be used for disaster countermeasures for earthquakes and typhoons. In addition, the NTN is assumed to be used for the wide area IoT for mountains, forests, and farmlands. In addition, the NTN is assumed to provide coverages on the sea and in the air. In addition, the NTN is assumed to be used as an industrial network using a portable base station for events, construction sites, or the like. In addition, the NTN is assumed to provide coverages in remote areas using repeaters, relays, and backhaul to base stations. In addition, the NTN is assumed to provide large capacity communications for ships and railways. In addition, the NTN is assumed to provide large capacity communications for aircrafts.

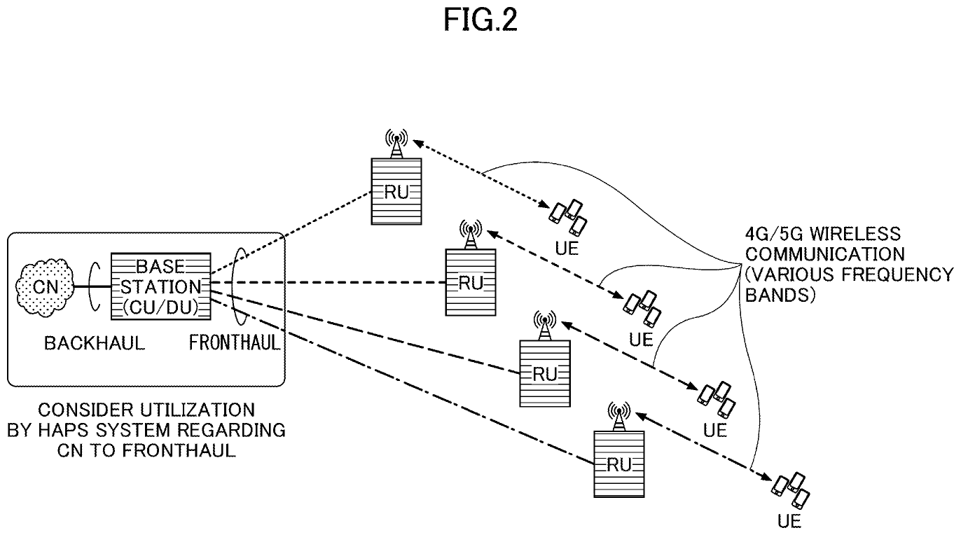

FIG. 2 is a drawing illustrating an example of a terrestrial network. As illustrated in FIG. 2, according to the advanced C-RAN (Centralized Radio Access Network) architecture, a plurality of antenna devices (RU: Radio Unit) can be distributed from a single base station (CU: Centralized Unit/DU: Distributed Unit). The terminal 20 is connected to an RU by using 4G or 5G wireless communications in various frequency bands. The RU is connected to a base station 10 via a fronthaul. The base station 10 is connected to a core network (CN) via a backhaul.

In addition, the terrestrial network may have a structure as described below. The terrestrial network may include one or more base stations 10 and terminals 20. The base station 10 is a communication device that provides one or more cells and performs wireless communication with the terminal 20. Physical resources of the radio signal may be defined in the time domain and the frequency domain, the time domain may be defined by the number of OFDM symbols, and the frequency domain may be defined by the number of sub-carriers or resource blocks. The base station 10 transmits a synchronization signal and system information to the terminal 20. The synchronization signal is, for example, an NR-PSS and an NR-SSS. The system information is transmitted via, for example, a NR-PBCH, and may be referred to as broadcast information.

The base station 10 transmits a control signal or data in DL (Downlink) to the terminal 20 and receives a control signal or data in UL (Uplink) from the terminal 20. The base station 10 and terminal 20 are capable of transmitting and receiving a signal by performing the beamforming. Further, the base station 10 and the terminal 20 can both apply MIMO (Multiple Input Multiple Output) communication to DL or UL. Further, both the base station 10 and terminal 20 may perform communications via an SCell (Secondary Cell) and a PCell (Primary Cell) using CA (Carrier Aggregation).

The terminal 20 may be a communication apparatus that includes a wireless communication function such as a smart-phone, a mobile phone, a tablet, a wearable terminal, a communication module for M2M (Machine-to-Machine), or the like. The terminal 20 uses various communication services provided by a wireless communication system, by receiving a control signal or data in DL from the base station 10 and transmitting a control signal or data in UL to the base station 10.

Here, even in the HAPS system, it is desirable to use the conventional 4G or 5G terrestrial network. For example, utilization by the HAPS system may be considered with respect to the terrestrial network from the core network to the fronthaul. In particular, the terrestrial network can be effectively utilized in the non-regenerative (transparent) system in which the HAPS is not equipped with a base station 10.

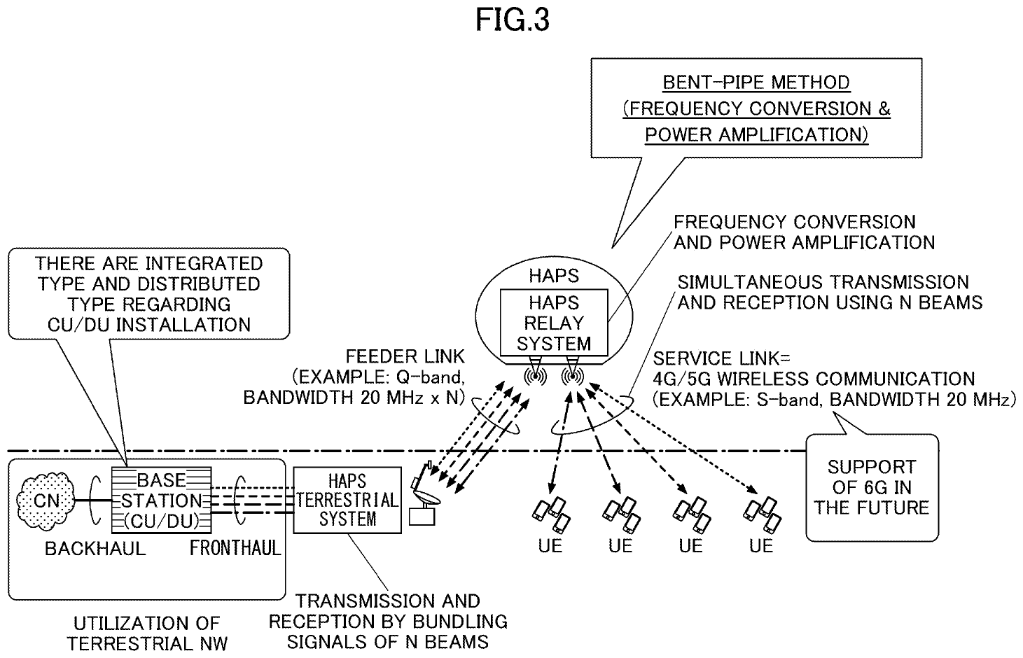

FIG. 3 is a drawing illustrating an example (1) of an NTN system in an embodiment of the present invention. FIG. 3 illustrates an example of a system configuration of the direct access (DA) and non-regenerative (transparent) architecture. As shown in FIG. 3, an NTN system in an embodiment of the present invention may include a HAPS terrestrial system and a HAPS relay system. The terrestrial network from the core network to the fronthaul is utilized. Regarding the base station 10, the installation form of CU/DU may be an integrated type or may be a distributed type.

The HAPS terrestrial system includes a function of an RU that provides conversion between a signal of an optical line of the fronthaul and an analog OFDM signal. In addition, the HAPS terrestrial system may transmit and receive N beams of signals of the service link (SL) by bundling them in the feeder link (FL). It is to be noted that the feeder link may use, for example, the Q band (from 33 GHz to 50 GHz) or may include the bandwidth 20 MHz×N.

The HAPS relay system provides a relay between the service link and the feeder link. The relay system may adopt a bent-pipe method of performing frequency conversion and power amplification. The service link may use the simultaneous transmission and reception using N beams, may use the 4G or 5G wireless communication, or may support the 6G wireless communication in the future. It is to be noted that the service link may use, for example, the S band (from 2 GHz to 4 GHZ), and the bandwidth of one service link may be 20 MHz.

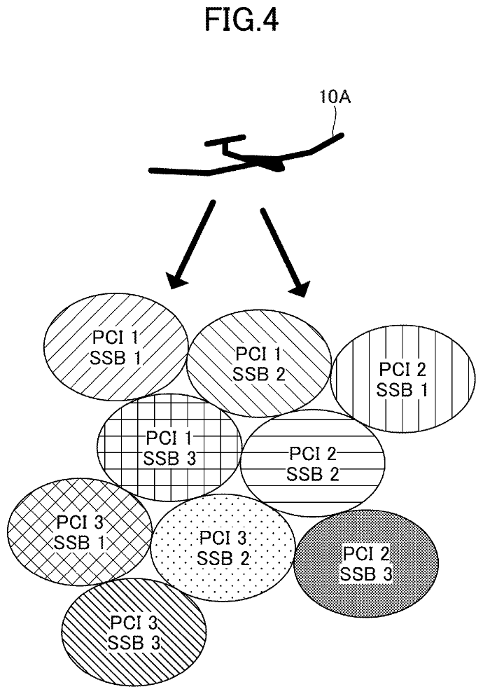

FIG. 4 is a drawing illustrating an example (1) of a beam operation in an embodiment of the present invention. As illustrated in FIG. 4, the HAPS relay system 10A may associate a plurality of beams with each cell. One cell may correspond to one PCI. The beams may be configured for each synchronization signal block (SSB). The layer 1 beam switching can be performed by associating a plurality of beams with each cell, and the delay can be decreased.

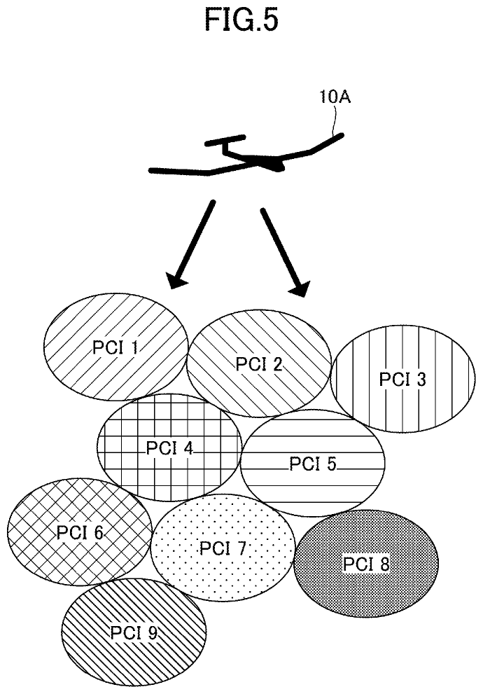

FIG. 5 is a drawing illustrating an example (2) of a beam operation in an embodiment of the present invention. As illustrated in FIG. 5, the HAPS relay system 10A may associate one beam with each cell. One cell may correspond to one PCI. The beams can be switched using a handover by associating one beam with each cell.

It is to be noted that, regarding the beam operation, an example illustrated in FIG. 4 may be adopted, or an example illustrated in FIG. 5 may be adopted.

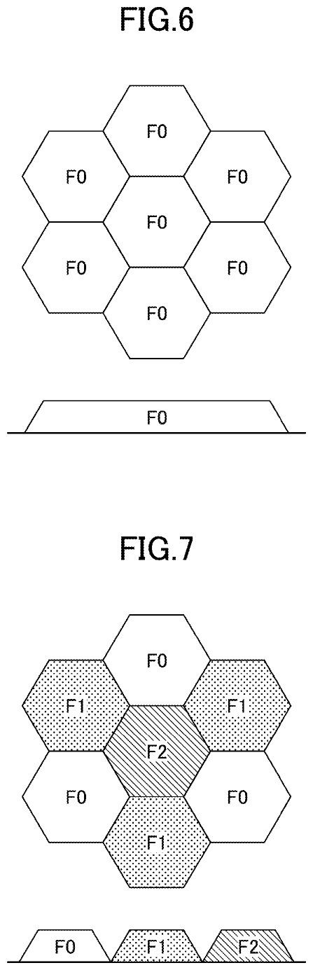

FIG. 6 is a drawing illustrating an example (1) of a frequency operation in an embodiment of the present invention. As illustrated in FIG. 6, a frequency FO may be reused for each beam. It is to be noted that one area illustrated in FIG. 6 may correspond to one beam, or may correspond to one cell.

FIG. 7 is a drawing illustrating an example (2) of a frequency operation in an embodiment of the present invention. A frequency F0, a frequency F1, and a frequency F2 may be used, and the frequencies may be reused according to the frequency allocation illustrated in FIG. 7. It is to be noted that one area illustrated in FIG. 7 may correspond to one beam, or may correspond to one cell.

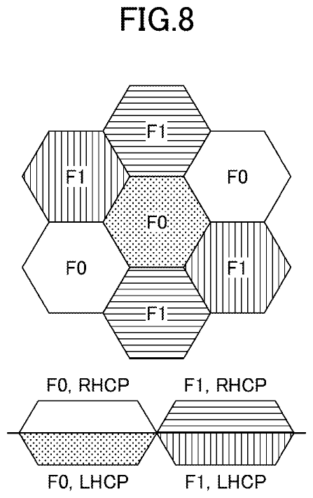

FIG. 8 is a drawing illustrating an example (3) of a frequency operation in an embodiment of the present invention. A frequency F0, a frequency F1, and a frequency F2 may be used, and in addition, RHCP (Right hand circularly polarized) and LHCP (Left hand circularly polarized) for each frequency may be used, and the frequencies may be reused according to the frequency allocation illustrated in FIG. 8. It is to be noted that one area illustrated in FIG. 8 may correspond to one beam, or may correspond to one cell.

It is to be noted that, regarding the reuse of frequencies, an example illustrated in FIG. 6 may be adopted, an example illustrated in FIG. 7 may be adopted, or an example illustrated in FIG. 8 may be adopted.

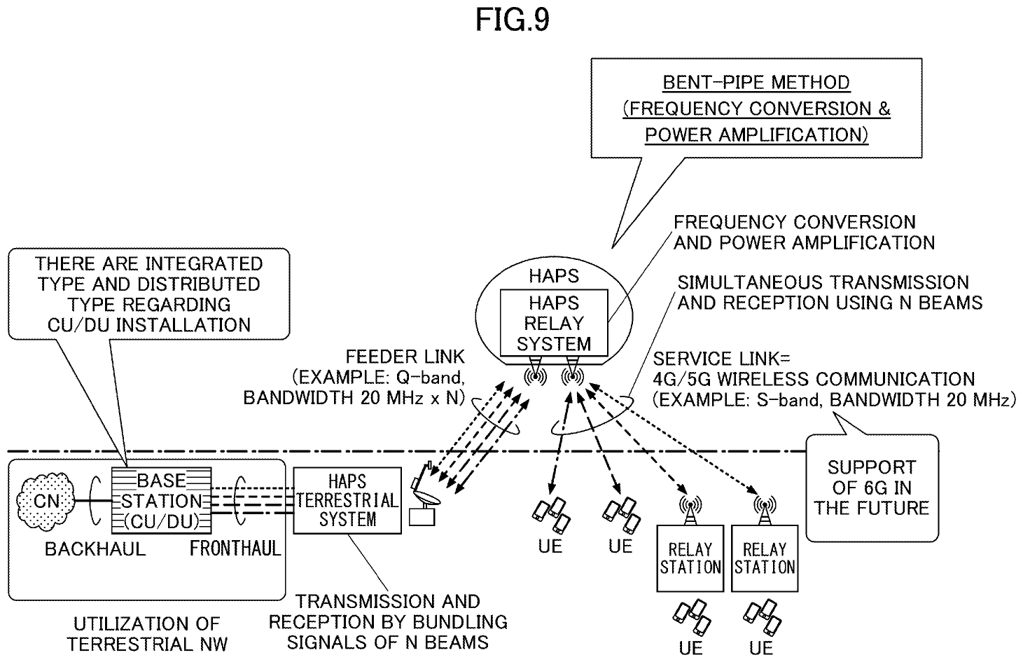

FIG. 9 is a drawing illustrating an example (2) of an NTN system in an embodiment of the present invention. As illustrated in FIG. 9, instead of directly performing, by the UE, transmission and reception to and from the service link connected to the HAPS relay system, the transmission and reception may be performed via a relay station (booster, attachment, or the like). In addition, as illustrated in FIG. 9, communications using a relay station can coexist with direct access, and may complement a case (for example, long distance, indoor environment, crowded area, or the like) in which the required performance cannot be achieved by the direct access. In a case where the service link uses high frequencies, communications using a relay station is assumed to be very effective.

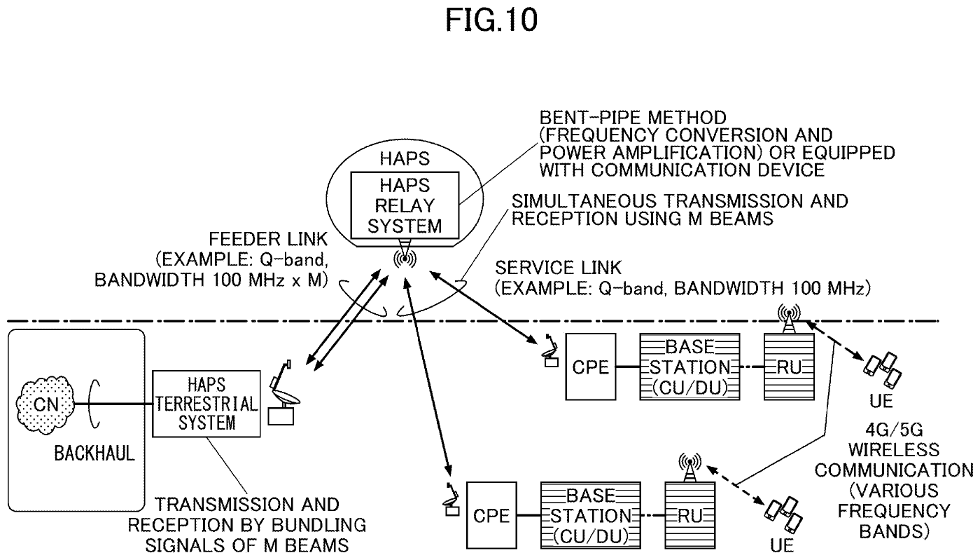

FIG. 10 is a drawing illustrating an example (3) of an NTN system in an embodiment of the present invention. As illustrated in FIG. 10, the configuration may be a configuration similar to that of the satellite CBH (Cellular Backhaul) system. In other words, the HAPS system may provide the backhaul between the core network and the base station as an independent tunnel line. In addition, as illustrated in FIG. 10, in addition to the bent-pipe type, the HAPS relay system may provide a regenerative-type relay by including the communication device.

As illustrated in FIG. 10, the service link may perform simultaneous transmission and reception using M beams, may use the Q band, and the bandwidth of one service link may be 100 MHz. The UE may be connected to the RU by using the 4G or 5G wireless communication, and furthermore may communicate with the HAPS relay system via the base station (CU/DU) and the CPE (Customer Premises Equipment). In addition, the feeder link may use, for example, the Q band, and may include the bandwidth 100 MHz×M.

When compared with the direct access CBH architecture illustrated in FIG. 9, the architecture illustrated in FIG. 10 can achieve the high-speed and large-capacity communication exceeding several hundreds of Mbps, for example, by applying the high frequency bands such as the Q band to the service link. In addition, the frequency bands of 4G or 5G wireless communications can be relatively freely deployed. On the other hand, when compared with the direct CBH architecture illustrated in FIG. 9, the architecture illustrated in FIG. 10 is required to have an additional system configuration added to the direct access.

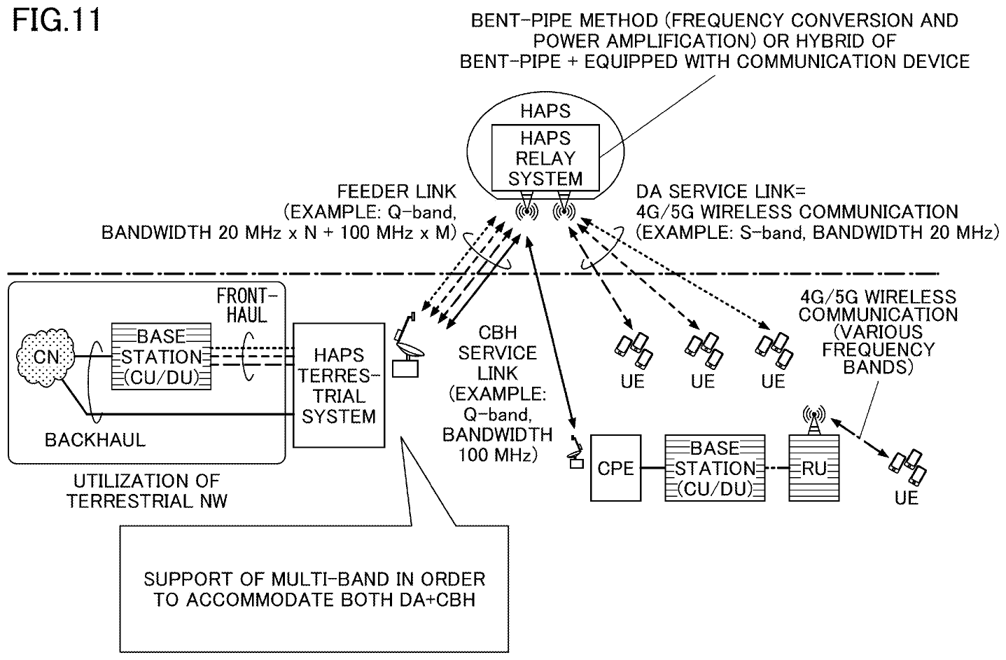

FIG. 11 is a drawing illustrating an example (4) of an NTN system in an embodiment of the present invention. As illustrated in FIG. 11, according to one HAPS relay system, both the direct access and the high-speed and large-capacity CBH may be supported, and various use cases may be implemented at the same time. Effective utilization of the machine body and radio resources of the HAPS relay system can be expected. For example, even in a case where the CBH is not used, the HAPS relay system can be used as direct access, and thus, such a situation can be avoided in which the machine body of the HAPS relay system is deployed but is not used. In addition, as illustrated in FIG. 10, the HAPS relay system may provide a regenerative-type relay by including the communication device in addition to providing the bent-pipe type, or may provide a hybrid-type in which the bent-type is supported and the communication device is included.

In addition, as illustrated in FIG. 11, the service link can be formed into a multi-band for direct access (for example, S band) and for CBH (for example, Q band). As illustrated in FIG. 11, the DA service link may perform simultaneous transmission and reception using M beams, may use the S band, and the bandwidth of one service link may be 20 MHz. As illustrated in FIG. 11, the CBH service link may perform simultaneous transmission and reception using N beams, may use the Q band, and the bandwidth of one service link may be 100 MHz. In addition, the feeder link may use, for example, the Q band, and may include the bandwidth 20 MHz×N and the bandwidth 100 MHz×M.

In addition, as illustrated in FIG. 10, in addition to the bent-pipe type, the HAPS relay system may provide a regenerative-type relay by including the communication device.

In addition, as illustrated in FIG. 11, the HAPS terrestrial system may utilize the terrestrial network by supporting a multi-band for accommodating both DA and CBH and supporting the fronthaul to the base station (CU/DU) and the backhaul to the core network.

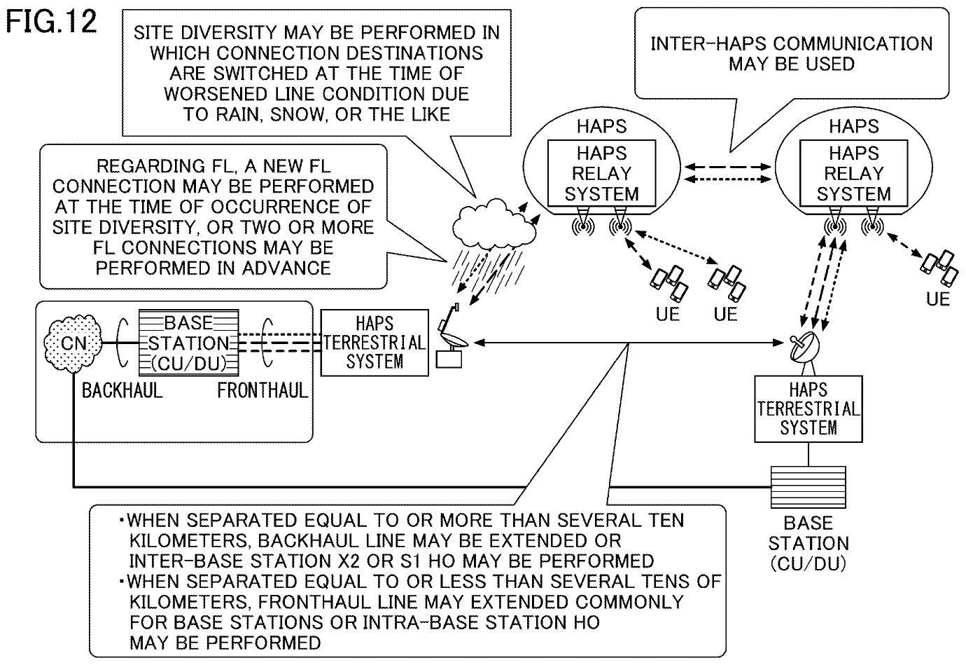

FIG. 12 is a drawing illustrating an example (5) of an NTN system in an embodiment of the present invention. As illustrated in FIG. 12, in the non-regenerative relay system, in particular, the handover control at the time of an occurrence of route switching (site diversity) due to rainfall, or the like, may be a handover control according to the method of the site diversity of the feeder link.

As illustrated in FIG. 12, in a case where the decreased line quality due to rainfall, snow, or the like, occurs, the HAPS relay system may perform the site diversity of switching the connection destinations. Regarding the feeder link, a new feeder link may be connected at the time of an occurrence of the site diversity, or two or more feeder links may be connected in advance. In addition, at the time of an occurrence of the site diversity, the feeder link may be configured by including another HAPS relay system by using the communication between HAPSs.

In a case where the HAPS terrestrial system of the handover destination is away from the HAPS terrestrial system of the handover source by several tens of kilometers, for example, the backhaul line may be extended, or an X2 handover or an S1 handover between base stations may be performed.

In a case where the HAPS terrestrial system of the handover destination is located within several tens of kilometers from the HAPS terrestrial system of the handover source, for example, the fronthaul line may be extended using a common base station, or an intra-base station handover may be performed.

The trigger of the above-described site diversity of switching the connection destinations may be, for example, a measurement report from the UE, may be a reference signal from the HAPS terrestrial system (CSI-RS (Channel State Information-Reference Signal)), or may be a rainfall amount prediction algorithm.

According to an embodiment of the present invention, in the NTN environment, the terrestrial network from the core network to the fronthaul can be utilized by introducing the HAPS relay system and the HAPS terrestrial system. In addition, the HAPS relay system can support both direct access and CBH.

In other words, it is possible to enhance the service areas by causing the NTN (Non-Terrestrial Network) and the terrestrial network to cooperate with each other.

### Device Configuration

Next, a functional configuration example of the base station 10 and the terminal 20 for performing the processes and operations described above will be described. The base station 10 and the terminal 20 include functions for implementing the embodiments described above. It should be noted, however, that each of the base stations 10 and the terminal 20 may include only some of the functions in an embodiment. It is to be noted that a device included in the non-terrestrial network and a device included in the terrestrial network may have a similar functional configuration as that of the base station 10.

### Base Station 10

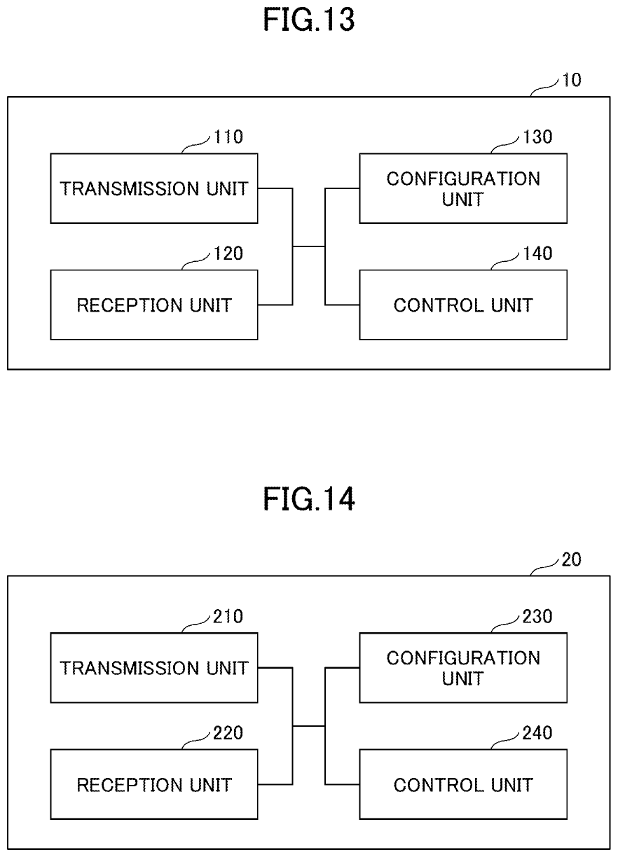

FIG. 13 is a drawing illustrating an example of a functional structure of a base station 10 according to an embodiment of the present invention. As shown in FIG. 13, the base station 10 includes a transmission unit 110, a reception unit 120, a configuration unit 130, and a control unit 140. The functional configuration illustrated in FIG. 13 is merely an example. Functional divisions and names of functional units may be anything as long as operations according to an embodiment of the present invention can be performed.

The transmission unit 110 includes a function for generating a signal to be transmitted to the terminal 20 side and transmitting the signal wirelessly. Further, the transmission unit 110 transmits an inter-network-node message to another network node. The reception unit 120 includes a function for receiving various signals transmitted from the terminal 20 and acquiring, for example, information of a higher layer from the received signals. Further, the transmission unit 110 has a function to transmit NR-PSS, NR-SSS, NR-PBCH, DL/UL control signals, and the like to the terminal 20. Further, the reception unit 120 receives an inter-network-node message from another network node.

The configuration unit 130 stores preset information and various configuration information items to be transmitted to the terminal 20. Contents of the configuration information are, for example, information related to communications in NTN.

The control unit 140 performs control related to communications in NTN as described in the embodiments. Further, the control unit 140 controls communications with the terminal 20 based on the radio-parameter-related UE capability report that is received from the UE 20. The functional units related to signal transmission in the control unit 140 may be included in the transmission unit 110, and the functional units related to signal reception in the control unit 140 may be included in the reception unit 120.

### Terminal 20

FIG. 14 is a drawing illustrating an example of a functional structure of a terminal 20 according to an embodiment of the present invention. As shown in FIG. 14, the terminal 20 includes a transmission unit 210, a reception unit 220, a configuration unit 230, and a control unit 240. The functional configuration illustrated in FIG. 14 is merely an example. Functional divisions and names of functional units may be anything as long as operations according to an embodiment of the present invention can be performed.

The transmission unit 210 generates a transmission signal from transmission data and transmits the transmission signal wirelessly. The reception unit 220 receives various signals wirelessly and obtains upper layer signals from the received physical layer signals. Further, the reception unit 220 has a function for receiving NR-PSS, NR-SSS, NR-PBCH, DL/UL/SL control signals, etc., transmitted from the base station 10. Further, for example, with respect to the D2D communications, the transmission unit 210 transmits, to another terminal 20, PSCCH (Physical Sidelink Control Channel), PSSCH (Physical Sidelink Shared Channel), PSDCH (Physical Sidelink Discovery Channel), PSBCH (Physical Sidelink Broadcast Channel), etc., and the reception unit 120 receives, from the another terminal 20, PSCCH, PSSCH, PSDCH, or PSBCH.

The configuration unit 230 stores various configuration information items received by the reception unit 220 from the base station 10. In addition, the configuration unit 230 also stores pre-configured configuration information. Contents of the configuration information are, for example, information related to communications in NTN.

The control unit 240 performs control related to communications in NTN as described in the embodiments. The functional units related to signal transmission in the control unit 240 may be included in the transmission unit 210, and the functional units related to signal reception in the control unit 240 may be included in the reception unit 220.

### Hardware Structure

In the above block diagrams used for describing an embodiment of the present invention (FIG. 13 and FIG. 14), functional unit blocks are shown. The functional blocks (function units) are realized by a freely-selected combination of hardware and/or software. Further, realizing means of each functional block is not limited in particular. In other words, each functional block may be realized by a single apparatus in which multiple elements are coupled physically and/or logically, or may be realized by two or more apparatuses that are physically and/or logically separated and are physically and/or logically connected (e.g., wired and/or wireless). The functional blocks may be realized by combining the above-described one or more apparatuses with software.

Functions include, but are not limited to, judging, determining, calculating, processing, deriving, investigating, searching, checking, receiving, transmitting, outputting, accessing, resolving, selecting, establishing, comparing, assuming, expecting, and deeming; broadcasting, notifying, communicating, forwarding, configuring, reconfiguring, allocating, mapping, and assigning, etc. For example, a functional block (component) that functions to transmit is called a transmitting unit or a transmitter. In either case, as described above, the implementation method is not particularly limited.

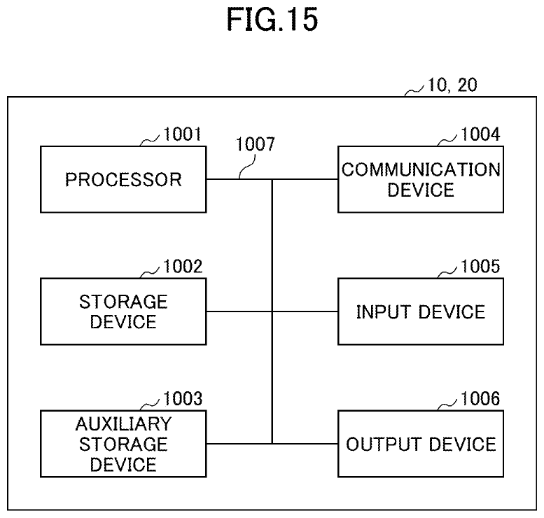

For example, each device of the non-terrestrial network, each device of the terrestrial network, and the terminal 20, etc., in an embodiment of the present disclosure may function as a computer for processing the wireless communication method of the present disclosure. FIG. 15 is a drawing illustrating an example of the hardware configuration of each device of the non-terrestrial network, each device of the terrestrial network, and the terminal 20 related to an embodiment of the present invention. Each device of the non-terrestrial network, each device of the terrestrial network and the terminal 20 may be physically a computer device including a processor 1001, a storage device 1002, an auxiliary storage device 1003, a communication device 1004, an input device 1005, an output device 1006, a bus 1007, etc.

It should be noted that, in the descriptions below, the term “device” can be read as a circuit, a device, a unit, etc. The hardware configuration of the base station 10, the terminal 20, each device of the non-terrestrial network, and each device of the terrestrial network may be configured to include one or more of each device shown in the figure or may be configured without some devices.

Each function of the base station 10, the terminal 20, each device of the non-terrestrial network, and each device of the terrestrial network is implemented by having the processor 1001 perform an operation by reading predetermined software (programs) onto hardware such as the processor 1001 and the storage device 1002, and by controlling communication by the communication device 1004 and controlling at least one of reading or writing of data in the storage device 1002 and the auxiliary storage device 1003.

The processor 1001 controls the entire computer by, for example, controlling the operating system. The processor 1001 may include a central processing unit (CPU) including an interface with a peripheral apparatus, a control apparatus, a calculation apparatus, a register, etc. For example, the above-described control unit 140, control unit 240, and the like, may be implemented by the processor 1001.

Further, the processor 1001 reads out onto the storage device 1002 a program (program code), a software module, or data from the auxiliary storage device 1003 and/or the communication device 1004, and performs various processes according to the program, the software module, or the data. As the program, a program is used that causes the computer to perform at least a part of operations according to an embodiment of the present invention described above. For example, the control unit 140 of the base station 10 illustrated in FIG. 13 may be realized by control programs that are stored in the storage device 1002 and are executed by the processor 1001. Further, for example, the control unit 240 of the terminal 20 illustrated in FIG. 14 may be realized by control programs that are stored in the storage device 1002 and are executed by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The storage device 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The storage device 1002 may be referred to as a register, a cache, a main memory, etc. The storage device 1002 is capable of storing programs (program codes), software modules, or the like, that are executable for performing communication processes according to an embodiment of the present invention.

The auxiliary storage device 1003 is a computer-readable recording medium, and may include at least one of, for example, an optical disk such as a CD-ROM (Compact Disc ROM), a hard disk drive, a flexible disk, a magneto optical disk (e.g., compact disc, digital versatile disc, Blu-ray (registered trademark) disk), a smart card, a flash memory (e.g., card, stick, key drive), a floppy (registered trademark) disk, a magnetic strip, etc. The above recording medium may be a database including the storage device 1002 and/or the auxiliary storage device 1003, a server, or any other appropriate medium.

The communication device 1004 is hardware (transmission or reception device) for communicating with computers via at least one of a wired network or a wireless network, and may be referred to as a network device, a network controller, a network card, a communication module, etc. The communication device 1004 may comprise a high frequency switch, duplexer, filter, frequency synthesizer, or the like, for example, to implement at least one of a frequency division duplex (FDD) or a time division duplex (TDD). For example, the transmitting/receiving antenna, the amplifier unit, the transmitting/receiving unit, the transmission line interface, and the like, may be implemented by the communication device 1004. The transmitting/receiving unit may be physically or logically divided into a transmitting unit and a receiving unit.

The input device 1005 is an input device that receives an external input (e.g., keyboard, mouse, microphone, switch, button, sensor). The output device 1006 is an output device that outputs something to the outside (e.g., display, speaker, LED lamp). It should be noted that the input device 1005 and the output device 1006 may be integrated into a single device (e.g., touch panel).

Further, the apparatuses including the processor 1001, the storage device 1002, etc., are connected to each other via the bus 1007 used for communicating information. The bus 1007 may include a single bus, or may include different buses between the apparatuses.

Further, each of the base station 10 and terminal 20 may include hardware such as a microprocessor, a digital signal processor (DSP), an ASIC (Application Specific Integrated Circuit), a PLD (Programmable Logic Device), a FPGA (Field Programmable Gate Array), etc., and a part or all of each functional block may be realized by the hardware. For example, the processor 1001 may be implemented by at least one of the above hardware elements.

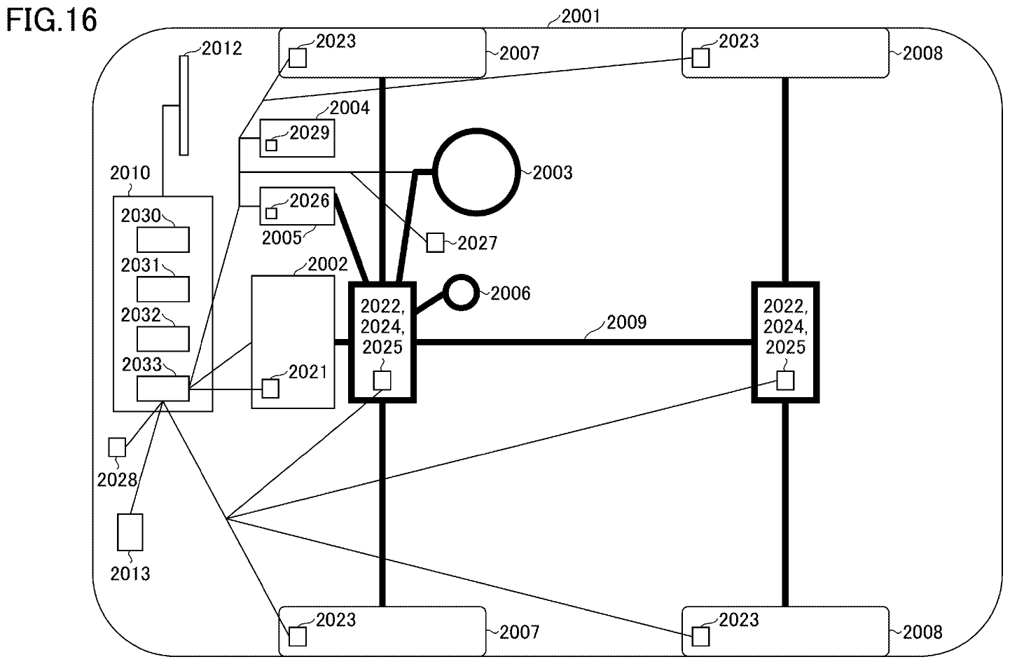

FIG. 16 shows an example of a configuration of a vehicle 2001. As shown in FIG. 16, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021-2029, an information service unit 2012, and a communication module 2013. The aspects/embodiments described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2029 provided in the vehicle 2001. The electronic control unit 2010 may be referred to as an ECU (Electronic control unit).

The signals from the various sensors 2021 to 2029 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021 to 2029 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits a current signal, which is input to the electronic control unit 2010 from the current sensor, to the external devices through radio communication. In addition, the communication module 2013 also transmits, to the external devices through radio communication, the front or rear wheel rotation signal acquired by the revolution sensor 2022, the front or rear wheel pneumatic signal acquired by the pneumatic sensor 2023, the vehicle speed signal acquired by the vehicle speed sensor 2024, the acceleration signal acquired by the acceleration sensor 2025, the stepped-on accelerator pedal signal acquired by the accelerator pedal sensor 2029, the stepped-on brake pedal signal acquired by the brake pedal sensor 2026, the operation signal of the shift lever acquired by the shift lever sensor 2027, and the detection signal, acquired by the object detection sensor 2028, for detecting an obstacle, a vehicle, a pedestrian, and the like, that are input to the electronic control unit 2010.

The communication module 2013 receives various types of information (traffic information, signal information, inter-vehicle information, etc.) transmitted from the external devices and displays the received information on the information service unit 2012 provided in the vehicle 2001. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021-2029, etc., mounted in the vehicle 2001.

### Embodiment Summary

As described above, a wireless communication system is provided. The wireless communication system includes: a non-terrestrial device; and a terrestrial device. The non-terrestrial device includes: a first control unit configured to establish a service link with a terminal and establish a feeder link with the terrestrial device; and a first communication unit configured to provide a relay between the service link and the feeder link, and the terrestrial device includes: a second control unit configured to establish the feeder link with the non-terrestrial device and establish a fronthaul with a base station; and a second communication unit configured to provide conversion between a signal of the fronthaul and a signal of the feeder link.

According to the above-described configuration, in the NTN environment, the terrestrial network from the core network to the fronthaul can be utilized by introducing the HAPS relay system and the HAPS terrestrial system. In addition, the HAPS relay system can support both direct access and CBH. In other words, it is possible to enhance the service areas by causing the NTN (Non-Terrestrial Network) and the terrestrial network to cooperate with each other.

The service link may be a direct access, the first control unit may establish a plurality of service links in a first band and establish the feeder link in a second band, the first communication unit may apply a beam to each service link of the plurality of service links to be simultaneously transmitted and received, the second control unit may establish the feeder link in the second band, and the second communication unit may bundle signals corresponding to the plurality of service links to be transmitted and received. According to the above-described configuration, in the NTN environment, the terrestrial network from the core network to the fronthaul can be utilized by introducing the HAPS relay system and the HAPS terrestrial system.

The service link may be formed as a CBH (Cellular Backhaul), the first control unit may establish a plurality of service links in a second band and establish the feeder link in the second band, the first communication unit may apply a beam to each service link of the plurality of service links to be simultaneously transmitted and received, the second control unit may establish the feeder link in the second band, and the second communication unit may bundle signals corresponding to the plurality of service links to be transmitted and received. According to the above-described configuration, in the NTN environment, the terrestrial network from the core network to the fronthaul can be utilized by introducing the HAPS relay system and the HAPS terrestrial system.

The service link may be formed as a direct access and CBH, the first control unit may establish a first plurality of service links in a first band, establish a second plurality of service links in a second band, and establish the feeder link in the second band, the first communication unit may apply a beam to each service link of the first plurality of service links to be simultaneously transmitted and received, and apply a beam to each service link of the second plurality of service links to be simultaneously transmitted and received, the second control unit may establish the feeder link in the second band, and the second communication unit may bundle signals corresponding to the first plurality of service links and signals corresponding to the second plurality of service links to be transmitted and received. According to the above-described configuration, in the NTN environment, the terrestrial network from the core network to the fronthaul can be utilized by introducing the HAPS relay system and the HAPS terrestrial system. In addition, the HAPS relay system can support both direct access and CBH.

In a case where quality of the feeder link is lowered, the first control unit may switch the terrestrial device for establishing the feeder link to another terrestrial device, and establish a new feeder link or use a feeder link that has been established with the another terrestrial device in advance. According to the above-described configuration, in the NTN environment, the site diversity can be performed by introducing the HAPS relay system and the HAPS terrestrial system.

In addition, according to an embodiment of the present invention, a wireless communication method performed by a wireless communication system including: a non-terrestrial device; and a terrestrial device is provided. The non-terrestrial device performs: establishing a service link with a terminal and establishing a feeder link with the terrestrial device; and providing a relay between the service link and the feeder link, and the terrestrial device performs: establishing the feeder link with the non-terrestrial device and establishing a fronthaul with a base station; and providing conversion between a signal of the fronthaul and a signal of the feeder link.

According to the above-described configuration, in the NTN environment, the terrestrial network from the core network to the fronthaul can be utilized by introducing the HAPS relay system and the HAPS terrestrial system. In addition, the HAPS relay system can support both direct access and CBH. In other words, it is possible to enhance the service areas by causing the NTN (Non-Terrestrial Network) and the terrestrial network to cooperate with each other.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, information indication may be performed not only by methods described in an aspect/embodiment of the present specification but also a method other than those described in an aspect/embodiment of the present specification. For example, the information indication may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block), SIB (System Information Block))), other signals, or combinations thereof. Further, RRC signaling may be referred to as an RRC message. The RRC signaling may be, for example, an RRC connection setup message, an RRC connection reconfiguration message, or the like.

Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), 6th generation mobile communication system (6G), xth generation mobile communication system (xG) (xG (x is, for example, an integer or a decimal)), FRA (Future Radio Access), NR (new Radio), New radio access (NX), Future generation radio access (FX), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next generation system enhanced, modified, developed, or defined therefrom. Further, multiple systems may also be applied in combination (e.g., at least one of LTE or LTE-A combined with 5G, etc.).

The order of processing steps, sequences, flowcharts or the like of an aspect/embodiment described in the present specification may be changed as long as there is no contradiction. For example, in a method described in the present specification, elements of various steps are presented in an exemplary order. The order is not limited to the presented specific order.

The particular operations, that are supposed to be performed by the base station 10 in the present specification, may be performed by an upper node in some cases. In a network including one or more network nodes including the base station 10, it is apparent that various operations performed for communicating with the terminal 20 may be performed by the base station 10 and/or another network node other than the base station 10 (for example, but not limited to, MME or S-GW). According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL) or wireless technologies (infrared, microwave, etc.), at least one of these wired line technologies or wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms “Base Station (BS)”, “Radio Base Station”, “Base Station Apparatus”, “Fixed Station”, “NodeB”, “eNodeB (eNB)”, “gNodeB (gNB)”, “Access Point”, “Transmission Point”, “Reception Point”, “Transmission/Reception Point”, “Cell”, “Sector”, “Cell Group”, “Carrier”, “Component Carrier”, and the like, may be used interchangeably. The base station may be referred to as a macro-cell, a small cell, a femtocell, a picocell and the like.

The base station may accommodate (provide) one or more (e.g., three) cells. In the case where the base station accommodates a plurality of cells, the entire coverage area of the base station may be divided into a plurality of smaller areas, each smaller area may provide communication services by means of a base station subsystem (e.g., an indoor small base station or a remote Radio Head (RRH)). The term “cell” or “sector” refers to a part or all of the coverage area of at least one of the base station and base station subsystem that provides communication services at the coverage.

In the present disclosure, terms such as “mobile station (MS)”, “user terminal”, “user equipment (UE)”, “terminal”, and the like, may be used interchangeably.

There is a case in which the mobile station may be referred to, by a person skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station or the mobile station may be referred to as a transmission apparatus, reception apparatus, communication apparatus, or the like. The at least one of the base station or the mobile station may be a device mounted on the mobile station, the mobile station itself, or the like. The mobile station may be a vehicle (e.g., a car, an airplane, etc.), an unmanned mobile body (e.g., a drone, an automated vehicle, etc.), or a robot (manned or unmanned). At least one of the base station or the mobile station may include an apparatus that does not necessarily move during communication operations. For example, at least one of the base station or the mobile station may be an IoT (Internet of Things) device such as a sensor.

Further, the base station in the present disclosure may be read as the user terminal. For example, each aspect/embodiment of the present disclosure may be applied to a configuration in which communications between the base station and the user terminal are replaced by communications between multiple terminals 20 (e.g., may be referred to as D2D (Device-to-Device), V2X (Vehicle-to-Everything), etc.). In this case, the function of the base station 10 described above may be provided by the terminal 20. Further, the phrases “up” and “down” may also be replaced by the phrases corresponding to terminal-to-terminal communication (e.g., “side”). For example, an uplink channel, a downlink channel, or the like, may be read as a sidelink channel.

Further, the user terminal in the present disclosure may be read as the base station. In this case, the function of the user terminal described above may be provided by the base station.

The term “determining” used in the present specification may include various actions or operations. The terms “determination” and “decision” may include “determination” and “decision” made with judging, calculating, computing, processing, deriving, investigating, searching (looking up, search, inquiry) (e.g., search in a table, a database, or another data structure), or ascertaining. Further, the “determining” may include “determining” made with receiving (e.g., receiving information), transmitting (e.g., transmitting information), inputting, outputting, or accessing (e.g., accessing data in a memory). Further, the “determining” may include a case in which “resolving”, “selecting”, “choosing”, “establishing”, “comparing”, or the like is deemed as “determining”. In other words, the “determining” may include a case in which a certain action or operation is deemed as “determining”. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description “based on” used in the present specification does not mean “based on only” unless otherwise specifically noted. In other words, the phrase “based on” means both “based on only” and “based on at least”.

Any reference to an element using terms such as “first” or “second” as used in the present disclosure does not generally limit the amount or the order of those elements. These terms may be used in the present disclosure as a convenient way to distinguish between two or more elements. Therefore, references to the first and second elements do not imply that only two elements may be employed or that the first element must in some way precede the second element.

“Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may include one or more frames in the time domain. Each of the one or more frames in the time domain may be referred to as a subframe. The subframe may further include one or more slots in the time domain. The subframe may be a fixed length of time (e.g., 1 ms) independent from the numerology.

The numerology may be a communication parameter that is applied to at least one of the transmission or reception of a signal or channel. The numerology may indicate at least one of, for example, SubCarrier Spacing (SCS), bandwidth, symbol length, cyclic prefix length, transmission time interval (TTI), number of symbols per TTI, radio frame configuration, specific filtering processing performed by the transceiver in the frequency domain, or specific windowing processing performed by the transceiver in the time domain.

The slot may include one or more symbols in the time domain, such as OFDM (Orthogonal Frequency Division Multiplexing) symbols, SC-FDMA (Single Carrier Frequency Division Multiple Access) symbols, and the like. The slot may be a time unit based on the numerology.

The slot may include a plurality of mini slots. Each mini slot may include one or more symbols in the time domain. Further, the mini slot may be referred to as a sub-slot. The mini slot may include fewer symbols than the slot. PDSCH (or PUSCH) transmitted in time units greater than a mini slot may be referred to as PDSCH (or PUSCH) mapping type A. PDSCH (or PUSCH) transmitted using a mini slot may be referred to as PDSCH (or PUSCH) mapping type B.

A radio frame, a subframe, a slot, a mini slot and a symbol all represent time units for transmitting signals. Different terms may be used for referring to a radio frame, a subframe, a slot, a mini slot and a symbol.

For example, one subframe may be referred to as a transmission time interval (TTI), multiple consecutive subframes may be referred to as a TTI, and one slot or one mini slot may be referred to as a TTI. In other words, at least one of the subframe and the TTI may be a subframe (1 ms) in an existing LTE, a period shorter than 1 ms (e.g., 1-13 symbols), or a period longer than 1 ms. It should be noted that the unit representing the TTI may be referred to as a slot, a mini slot, or the like, rather than a subframe.

The TTI refers to, for example, the minimum time unit for scheduling in wireless communications. For example, in an LTE system, a base station schedules each terminal 20 to allocate radio resources (such as frequency bandwidth, transmission power, etc. that can be used in each terminal 20) in TTI units. The definition of TTI is not limited to the above.

The TTI may be a transmission time unit, such as a channel-encoded data packet (transport block), code block, codeword, or the like, or may be a processing unit, such as scheduling or link adaptation. It should be noted that, when a TTI is provided, the time interval (e.g., the number of symbols) during which the transport block, code block, codeword, or the like, is actually mapped may be shorter than the TTI.

It should be noted that, when one slot or one mini slot is referred to as a TTI, one or more TTIs (i.e., one or more slots or one or more mini slots) may be the minimum time unit for scheduling. Further, the number of slots (the number of mini slots) constituting the minimum time unit of the scheduling may be controlled.

A TTI having a time length of 1 ms may be referred to as a normal TTI (a TTI in LTE Rel. 8-12), a long TTI, a normal subframe, a long subframe, a slot, and the like. A TTI that is shorter than the normal TTI may be referred to as a shortened TTI, a short TTI, a partial TTI (or fractional TTI), a shortened subframe, a short subframe, a mini slot, a subslot, a slot, or the like.

It should be noted that the long TTI (e.g., normal TTI, subframe, etc.,) may be replaced with a TTI having a time length exceeding 1 ms, and the short TTI (e.g., shortened TTI, etc.,) may be replaced with a TTI having a TTI length less than the TTI length of the long TTI and a TTI length greater than 1 ms.

A resource block (RB) is a time domain and frequency domain resource allocation unit and may include one or more consecutive subcarriers in the frequency domain. The number of subcarriers included in an RB may be the same, regardless of the numerology, and may be 12, for example. The number of subcarriers included in an RB may be determined on the basis of numerology.

Further, the time domain of an RB may include one or more symbols, which may be 1 slot, 1 mini slot, 1 subframe, or 1 TTI in length. One TTI, one subframe, etc., may each include one or more resource blocks.

It should be noted that one or more RBs may be referred to as physical resource blocks (PRBs, Physical RBs), sub-carrier groups (SCGs), resource element groups (REGs), PRB pairs, RB pairs, and the like.

Further, a resource block may include one or more resource elements (RE). For example, 1 RE may be a radio resource area of one sub-carrier and one symbol.

The bandwidth part (BWP) (which may also be referred to as a partial bandwidth, etc.) may represent a subset of consecutive common RBs (common resource blocks) for a given numerology in a carrier. Here, a common RB may be identified by an index of RB relative to the common reference point of the carrier. A PRB may be defined in a BWP and may be numbered within the BWP.

BWP may include BWP for UL (UL BWP) and BWP for DL (DL BWP). For a UE, one or more BWPs may be configured in one carrier.

At least one of the configured BWPs may be activated, and the UE may assume that the UE will not transmit and receive signals/channels outside the activated BWP. It should be noted that the terms “cell” and “carrier” in this disclosure may be replaced by “BWP.”

Structures of a radio frame, a subframe, a slot, a mini slot, and a symbol described above are exemplary only. For example, the number of subframes included in a radio frame, the number of slots per subframe or radio frame, the number of mini slots included in a slot, the number of symbols and RBs included in a slot or mini slot, the number of subcarriers included in an RB, the number of symbols in a TTI, the symbol length, the cyclic prefix (CP) length, and the like, may be changed in various ways.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

An aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

It is to be noted that, in this disclosure, the HAPS relay system is an example of a non-terrestrial device. The HAPS terrestrial system is an example of a terrestrial device.

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

The present application is based on and claims priority to Japanese patent application No. 2022-018544 filed on Feb. 9, 2022, the entire contents of which are hereby incorporated herein by reference.

### DESCRIPTION OF THE REFERENCE NUMERALS

10 Base station
110 Transmission unit
120 Reception unit
130 Configuration unit
140 Control unit
20 Terminal
210 Transmission unit
220 Reception unit
230 Configuration unit
240 Control unit
1001 Processor
1002 Storage device
1003 Auxiliary storage device
1004 Communication device
1005 Input device
1006 Output device

1. A wireless communication system comprising: a non-terrestrial device and a terrestrial device, wherein
the non-terrestrial device includes:
a first control unit configured to establish a service link with a terminal and establish a feeder link with the terrestrial device; and
a first communication unit configured to provide a relay between the service link and the feeder link, and
the terrestrial device includes:
a second control unit configured to establish the feeder link with the non-terrestrial device and establish a fronthaul with a base station; and
a second communication unit configured to provide conversion between a signal of the fronthaul and a signal of the feeder link.

2. The wireless communication system as claimed in claim 1, wherein
the service link is a direct access,
the first control unit establishes a plurality of service links in a first band and establishes the feeder link in a second band,
the first communication unit applies a beam to each service link of the plurality of service links to be simultaneously transmitted and received,
the second control unit establishes the feeder link in the second band, and
the second communication unit bundles signals corresponding to the plurality of service links to be transmitted and received.

3. The wireless communication system as claimed in claim 1, wherein
the service link is formed as a CBH (Cellular Backhaul),
the first control unit establishes a plurality of service links in a second band and establishes the feeder link in the second band,
the first communication unit applies a beam to each service link of the plurality of service links to be simultaneously transmitted and received,
the second control unit establishes the feeder link in the second band, and
the second communication unit bundles signals corresponding to the plurality of service links to be transmitted and received.

4. The wireless communication system as claimed in claim 1, wherein
the service link is formed as a direct access and CBH,
the first control unit establishes a first plurality of service links in a first band, establishes a second plurality of service links in a second band, and establishes the feeder link in the second band,
the first communication unit applies a beam to each service link of the first plurality of service links to be simultaneously transmitted and received, and applies a beam to each service link of the second plurality of service links to be simultaneously transmitted and received,
the second control unit establishes the feeder link in the second band, and
the second communication unit bundles signals corresponding to the first plurality of service links and signals corresponding to the second plurality of service links to be transmitted and received.

5. The wireless communication system as claimed in claim 1, wherein
in a case where quality of the feeder link is lowered, the first control unit switches the terrestrial device for establishing the feeder link to another terrestrial device, and establishes a new feeder link or uses a feeder link that has been established with the another terrestrial device in advance.

6. A wireless communication method performed by a wireless communication system comprising: a non-terrestrial device and a terrestrial device, wherein
the non-terrestrial device performs:
establishing a service link with a terminal and establishing a feeder link with the terrestrial device; and
providing a relay between the service link and the feeder link, and
the terrestrial device performs:
establishing the feeder link with the non-terrestrial device and establishing a fronthaul with a base station; and
providing conversion between a signal of the fronthaul and a signal of the feeder link.
